(19) United States
(12) Patent Application Publication
(10) Pub. No.: US 2022/0179296 A1
(43) Pub. Date: Jun. 9, 2022

(54) MANUFACTURING METHOD OF PROJECTION APPARATUS BY CLASSIFYING LIGHT VALVE ACCORDING TO BRIGHTNESS

(71) Applicant: Young Optics Inc., Hsinchu (TW)

(72) Inventors: Yu-Po Chen, Hsinchu (TW); Chun-Chieh Li, Hsinchu (TW); Wei-Szu Lin, Hsinchu (TW); Yi-Hsueh Chen, Hsinchu (TW)

(73) Assignee: Young Optics Inc., Hsinchu (TW)

(21) Appl. No.: 17/676,850

(22) Filed: Feb. 22, 2022

Related U.S. Application Data
(63) Continuation of application No. 15/940,999, filed on Mar. 30, 2018, now abandoned.

(51) Int. Cl. G03B 21/00; G02B 27/10; G03B 21/54

(52) U.S. Cl. CPC G03B 21/008; G03B 21/54; G02B 27/1073

(57) ABSTRACT

A manufacturing method of a projection apparatus is provided. The manufacturing method of the projection apparatus includes: classifying a light valve by using an optical jig which includes a lens with a constant aperture; selecting an aperture stop with a size corresponding to classification of the light valve; and assembling the light valve and the aperture stop to form the projection apparatus.

This application is a continuation application of and claims the priority benefit of U.S. application Ser. No. 15/940,999, filed on Mar. 30, 2018, now pending. The entirety of the above-mentioned patent application is hereby incorporated by reference herein and made a part of this specification.

### BACKGROUND OF THE INVENTION

### 1. Field of the Invention

The invention generally relates to a manufacturing method and, in particular, to a manufacturing method of a projection apparatus.

### 2. Description of Related Art

In the display technology, a projection apparatus, i.e. projector, plays an important role of large size displaying. Compared with a large size liquid crystal display (LCD) or an large size organic light-emitting diode (OLED) display having a large cost and large size, a projection apparatus can achieve a large size displaying effect by a small size and low cost. Moreover, by the optical magnification effect of a projection lens, the displaying size provided by a projection apparatus is easy to exceed the displaying size of an LCD, OLED display, or any other type of display.

Nowadays, the resolution of an LCD or OLED display is increased, for example, to 4K. Therefore, the resolution of a projection apparatus is also increased by reducing the pixel size of a light valve, e.g. a digital micro-mirror device (DMD). A tilt and roll pixel digital micro-mirror device (TRP DMD) is developed to increase the light amount input into the projection lens from a pixel when the pixel is designed to be small. Each micro-mirror of a TRP DMD can be tilted in two directions. By pre-tilting the micro-mirror in one of the two directions and then rolling back and forth the micro-mirror in the other one of the two directions between an on-state and an off-state, the total tilt angle of the micro-mirror is increased, so as to improve the light amount input into the projection lens. Besides, a pico-projector having a small size is also developed, and it also needs a light valve, e.g. a DMD, having a small pixel size.

Since the micro-mirrors of a DMD form a periodical structure, the light diffracted by the micro-mirrors may be input to the projection lens when the micro-mirrors are at an off-state, which reduces the contrast of the image. When the pixel size of a DMD is reduced, the diffraction effect due to the micro-mirrors is increased and the image contrast is further reduced. Moreover, a TRP DMD has a larger tolerance of the tilted angle of the micro-mirrors when compared with a traditional DMD, which also reduces the contrast of the image.

### SUMMARY OF THE INVENTION

Accordingly, the invention is directed to a manufacturing method of a projection apparatus, by which a projection apparatus having high image contrast can be insured.

According to an embodiment of the invention, a manufacturing method of a projection apparatus is provided. The manufacturing method of the projection apparatus includes: classifying a plurality of digital micro-mirror devices (DMDs) into a first group and a second group according to dark state brightness of each of the DMDs, wherein each of micro-mirrors of the DMDs has two different tilting axes; and assembling one of following sets into the projection apparatus: Set (1): a DMD of the first group with a first aperture stop; Set (2): a DMD of the second group with a second aperture stop, wherein dark state brightness of the first group is less than dark state brightness of the second group, and a light blocking area of the first aperture stop is less than a light blocking area of the second aperture stop.

According to an embodiment of the invention, a manufacturing method of a projection apparatus is provided. The manufacturing method of the projection apparatus includes: classifying a plurality of digital micro-mirror devices (DMDs) into a first group and a second group according to dark state brightness of each of the DMDs, wherein a diffracted light of an off-state of each of the DMDs overlaps a path of an on-state light beam of the DMD; and assembling one of following sets into the projection apparatus: Set (1): a DMD of the first group with a first aperture stop; Set (2): a DMD of the second group with a second aperture stop, wherein dark state brightness of the first group is less than dark state brightness of the second group, and a light blocking area of the first aperture stop is less than a light blocking area of the second aperture stop.

According to an embodiment of the invention, a manufacturing method of a projection apparatus is provided. The manufacturing method of the projection apparatus includes: putting a light valve on an optical jig; providing a light beam to the light valve, wherein the light valve converts the light beam in to an image beam, and the optical jig projects the image beam onto an image plane; measuring brightness on the image plane when the light valve shows a dark frame; classifying the light valve according to the brightness on the image plane; selecting an aperture stop with a size corresponding to classification of the light valve; and assembling the light valve and the aperture stop to form the projection apparatus.

In the manufacturing method of the projection apparatus according to the embodiment of the invention, the light valve or DMD is first classified, so that an aperture stop matching the light valve or DMD can be then selected so as to insure a high image contrast provided by the projection apparatus.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a flow chart of a manufacturing method of a projection apparatus according to an embodiment of the invention.

FIG. 2 is a schematic cross-sectional view showing a light valve being put on an optical jig in the manufacturing method of the projection apparatus in FIG. 1.

FIG. 3A and FIG. 3B respectively show two types of aperture stops which can be selected in the manufacturing method of the projection apparatus in FIG. 1.

FIG. 4A shows an on-state light beam, an off-state light beam, and diffracted light of a projection apparatus.

FIG. 4B shows orthogonal projections, onto a plane parallel to the light valve, of traveling directions of a light beam incident on the light valve and an off-state light beam of the light valve with respect to two tilting axes of micro-mirrors of the light valve.

FIG. 5 is a schematic cross-sectional view of a projection apparatus assembled by the manufacturing method of FIG. 1.

FIG. 6A is a diagram of the image contrast of the optical jig when different light valves are put therein in sequence vs. dark state brightness of the light valves.

FIG. 6B is a diagram of the image contrast of the projection apparatus in FIG. 5 when different light valves having dark state brightness less than or equal to 20 lux are assembled therein with the aperture stop shown in FIG. 3A in sequence vs. the serial number of measurement.

FIG. 6C is a diagram of the image contrast of the projection apparatus in FIG. 5 when different light valves having dark state brightness greater than 20 and less than or equal to 22 are assembled therein with the aperture stop shown in FIG. 3B in sequence vs. the image brightness of the projection apparatus.

FIG. 6D is a diagram of the image contrast of the projection apparatus in FIG. 5 when different light valves having dark state brightness greater than 22 and less than or equal to 25 are assembled therein with the aperture stop shown in FIG. 3B in sequence vs. the image brightness of the projection apparatus.

FIG. 6E is a diagram of the image contrast of the projection apparatus in FIG. 5 when different light valves having dark state brightness greater than 25 and less than or equal to 28 are assembled therein with the aperture stop shown in FIG. 3B in sequence vs. the image brightness of the projection apparatus.

FIG. 7 shows another type of aperture stop which can be selected in a manufacturing method of the projection apparatus according to another embodiment of the invention.

FIG. 8A shows orthogonal projections, onto a plane parallel to the light valve, of traveling directions of a light beam incident on the light valve and an off-state light beam of the light valve with respect to two tilting axes of micro-mirrors of the light valve in another embodiment of the invention.

FIG. 8B shows an on-state light beam, an off-state light beam, and diffracted light of a projection apparatus according to the embodiment of FIG. 8A.

FIG. 8C shows the aperture stop adopted by the embodiment of FIG. 8A.

### DESCRIPTION OF THE EMBODIMENTS

Reference will now be made in detail to the present embodiments of the invention, examples of which are illustrated in the accompanying drawings. Wherever possible, the same reference numbers are used in the drawings and the description to refer to the same or like parts.

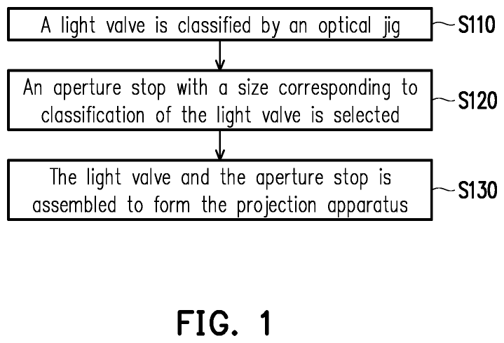

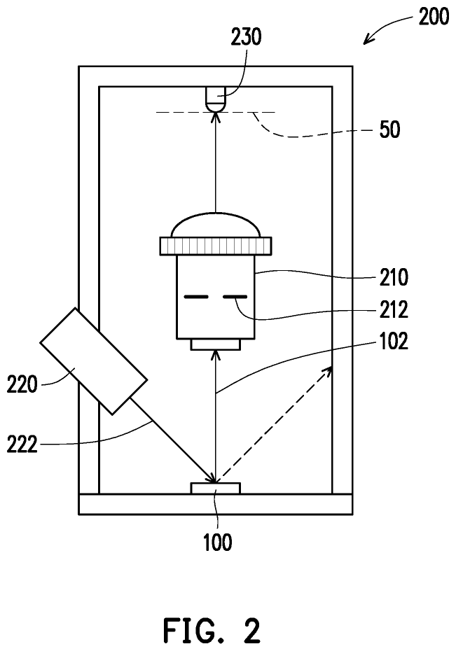

FIG. 1 is a flow chart of a manufacturing method of a projection apparatus according to an embodiment of the invention, and FIG. 2 is a schematic cross-sectional view showing a light valve being put on an optical jig in the manufacturing method of the projection apparatus in FIG. 1. Referring to FIG. 1 and FIG. 2, a manufacturing method of a projection apparatus in this embodiment includes the following steps. First, step S110 is performed, which is classifying a light valve 100 by an optical jig 200. In this embodiment, the light valve 100 is put on the optical jig 200. The light valve 100 may be a DMD, for example, a TRP DMD. The optical jig 200 is, for example a standard projector. In this embodiment, the optical jig 200 includes a lens 210 with a constant aperture 212 to project light from the light valve 100 onto an image plane 50.

Next, a light beam 222 is provided to the light valve 100, the light valve 100 converts the light beam 222 into an image beam 102, and the optical jig 200 projects the image beam 102 onto the image plane 50. Specifically, the optical jig 200 may further include an illumination system 220 configured to provide the light beam 222 to the light valve 100. The lens 210 with the constant aperture 212 is configured to project the image beam 102 from the light valve 100 onto the image plane 50. Then, brightness, i.e. the dark state brightness of the light valve 100, on the image plane is measured when the light valve 100 shows a dark frame. In this embodiment, an optical meter 230 is configured to measure the brightness on the image plane. The optical meter 230 is, for example, an illuminometer configured to measure the illuminance at the center of the image beam 102 on the image plane 50.

After that, the light valve 100 is classified according to the dark state brightness on the image plane. In this embodiment, each class of the light valve 100 corresponds to a different dark state brightness range, and a class of the light valve 100 corresponding to a dark state brightness range having greater dark state brightness corresponds to an aperture stop 300 having a smaller aperture 310. In this embodiment, a plurality of light valves 100 (e.g. DMDs) are classified into a first group and a second group according to dark state brightness of each of the light valves 100. For example, a light valve 100 having dark state brightness less than or equal to 20 lux is classified as class 1 (i.e. the first group), and a light valve 100 having dark state brightness greater than 20 lux and less than or equal to 28 lux is classified as class 2 (i.e. the second group).

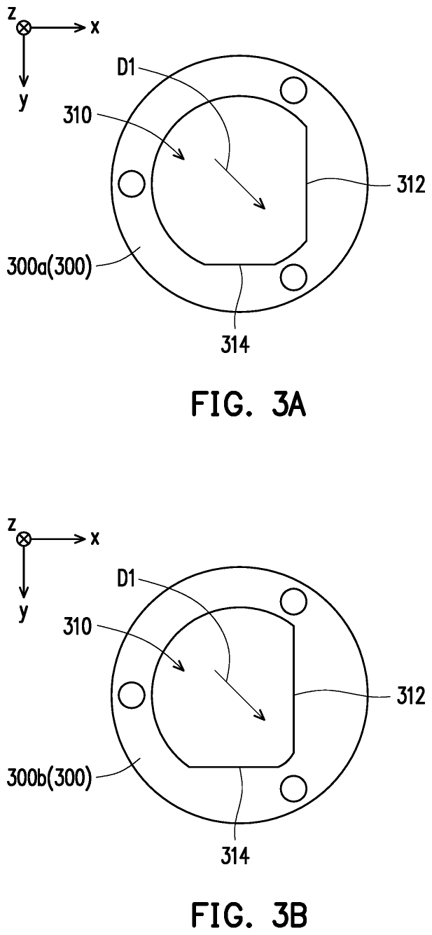

FIG. 3A and FIG. 3B respectively show two types of aperture stops which can be selected in the manufacturing method of the projection apparatus in FIG. 1. Referring to FIG. 1, FIG. 2, FIG. 3A and FIG. 3B, afterward, step S120 is performed, which is selecting an aperture stop 300 with a size corresponding to classification of the light valve 100. For example, for the light valve 100 classified as class 1 (i.e. the first group), dark state brightness is weaker, so that an aperture stop 300a (i.e. a first aperture stop) shown in FIG. 3A with a larger aperture 310 is selected, so as to form Set (1): a light valve 100 of the first group with a first aperture stop. On the other hand, for the light valve 100 classified as class 2 (i.e. the second group), dark state brightness is stronger, so that an aperture stop 300b (i.e. a second aperture stop) shown in FIG. 3B with a smaller aperture 310 is selected, so as to form Set (2): a light valve 100 of the second group with a second aperture stop. In other words, dark state brightness of the first group is less than dark state brightness of the second group, and a light blocking area of the first aperture stop is less than a light blocking area of the second aperture stop.

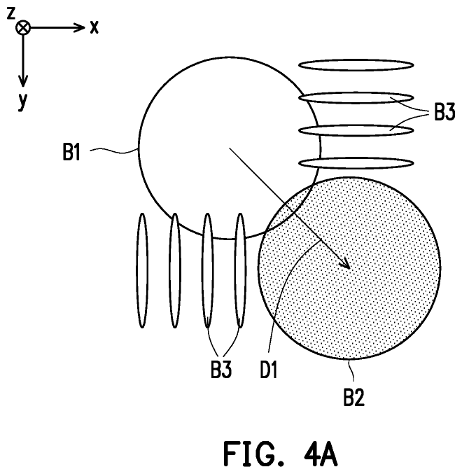

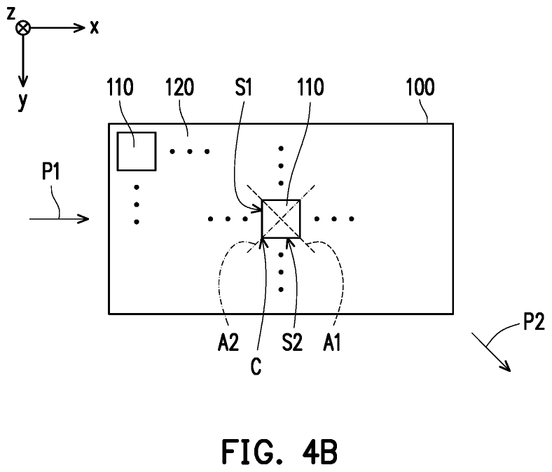

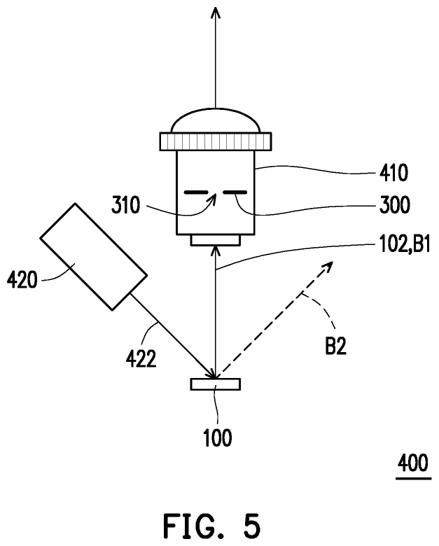

FIG. 4A shows an on-state light beam, an off-state light beam, and diffracted light of a projection apparatus, FIG. 4B shows orthogonal projections, onto a plane parallel to the light valve, of traveling directions of a light beam incident on the light valve and an off-state light beam of the light valve with respect to two tilting axes of micro-mirrors of the light valve, and FIG. 5 is a schematic cross-sectional view of a projection apparatus assembled by the manufacturing method of FIG. 1. Referring to FIG. 3A, FIG. 3B, FIG. 4A, and FIG. 5, the aperture stop 300 has the aperture 310 having two straight sides 312 and 314, a rotation direction D1 (shown in FIG. 3A, FIG. 3B, and FIG. 4A) of an on-state light beam B1 to an off-state light beam B2 of the light valve 100 parallel to the light valve 100 and an extension direction of each of the two straight sides 312 and 314 make an included angle, and the included angle is substantially 45 degrees. In this embodiment, “the included angle is substantially 45 degrees” means that the included angle ranges from 43 degrees to 47 degrees. For a TRP DMD, a diffracted light B3 of an off-state of the DMD overlaps a path of an on-state light beam B1 of the DMD as shown in FIG. 4A. The design of the two straight sides 312 and 314 may be used to block diffracted light B3 diffracted by the micro-mirror array of the light valve 100 at the off-state. In this embodiment, the area of the aperture 310 of the aperture stop 300a is greater than the area of the aperture 310 of the aperture stop 300b. Moreover, when the aperture stop 300a coincides with the aperture stop 300b, the straight side 312 of the aperture stop 300b is on the left side (−x-direction side) of the straight side 312 of the aperture stop 300a, and the straight side 314 of the aperture stop 300b is on the top side (−y-direction side) of the straight side 314 of the aperture stop 300a.

Referring to FIG. 1, FIG. 3A, FIG. 3B, FIG. 4B and FIG. 5, after that, step S130 is performed, which is assembling the light valve 100 and the aperture stop 300 to form the projection apparatus 400. That is, one of the aforementioned Set (1) and Set (2) is assembled into the projection apparatus 400. In this embodiment, if a light valve 100 is classified as class 1, the light valve 100 and the aperture stop 300a in FIG. 3A are assembled to form the projection apparatus 400. On the other hand, if a light valve 100 is classified as class 2, the light valve 100 and the aperture stop 300b in FIG. 3B are assembled to form the projection apparatus 400. To assemble the projection apparatus 400, an illumination system 420, a projection lens 410 having the aperture 300, a housing, other components, or any combination thereof may be assembled with the light valve 100 to form the projection apparatus 400. The illumination system 420 provides a light beam 422 to the light valve 100. The light valve 100 converts the light beam 422 into an image beam 102 (i.e. the on-state light beam B1). The projection lens 410 may project the image beam 102 onto a screen to form an image. The off-state light beam B2 reflected by the light valve 100 does not enter the projection lens 410.

In this embodiment, the light valve 100 is, for example, a TRP DMD. The light valve 100 includes a plurality of micro-mirrors 110 arranged in an array. Each of the micro-mirrors 110 of the TRP DMD has two different tilting axes A1 and A2. When a micro-mirror 110 works, the micro-mirror 110 is pre-tilted about the tilting axis A1 by, for example, 12 degrees, so that the corner C of the micro-mirror 110 moves down towards a substrate 120 of the TRP DMD. Then, the micro-mirror 110 rolls about the tilting axis A2 between, for example, −12 degrees and +12 degrees so that the micro-mirror 110 is switched between the on-state and the off-state. When the micro-mirror 110 is at the on-state, the side S1 is the landed edge of the micro-mirror 110 (e.g. the edge of the micro-mirror 110 closest to the substrate 120. When the micro-mirror 110 is at the off-state, the side S2 is the landed edge. In this embodiment, the projection apparatus 400 adopts a structure of side illumination, so that an orthogonal projection P1, onto a plane (e.g. xy plane) parallel to the light valve 100, of the traveling direction of the light beam 422 incident on the light valve 100 is towards the short side of the light valve 100, and an orthogonal projection P2, onto a plane (e.g. xy plane) parallel to the light valve 100, of an off-state light beam B2 of the light valve 100 is towards the x+y directions.

In this embodiment, after the light valve 100 classified by the optical jig 200 (e.g. between step S110 and step S120, a part number is assigned to the light valve 100, wherein the part number corresponds to the classification of the light valve 100. For example, a first part number may be assigned to the light valve 100 of class 1, and a second part number may be assigned to the light valve 100 of class 2. Then, the light valve 100 with the part number is put into storage. After that, when the projection apparatus 400 is assembled, selecting the aperture stop 300 with the size corresponding to the classification of the light valve 100 is selecting the aperture stop 300 with the size corresponding to the part number. For example, if the light valve 100 with the first part number is got from storage, the aperture stop 300a is selected. On the other hand, if the light valve 100 with the second part number is got from storage, the aperture stop 300b is selected. However, the steps of assigning the part number and putting the light valve 100 with the part number into storage may be omitted in other embodiments.

In the manufacturing method of the projection apparatus 400 according to this embodiment, the light valve 100 is first classified, so that an aperture stop 300 matching the light valve 100 can be then selected so as to insure a high image contrast provided by the projection apparatus 400. That is, for the light valve 100 having higher dark state brightness, an aperture stop 300 with a smaller aperture 310 is selected to maintain high image contrast. On the other hand, for the light valve 100 having lower dark state brightness, an aperture stop 300 with a larger aperture 310 can be selected to increase the image brightness while maintaining high image contrast.

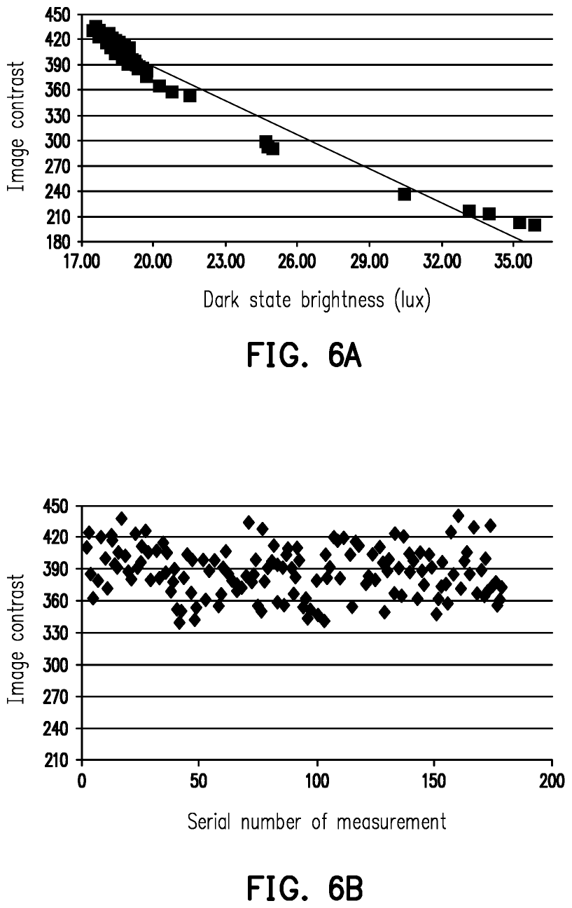

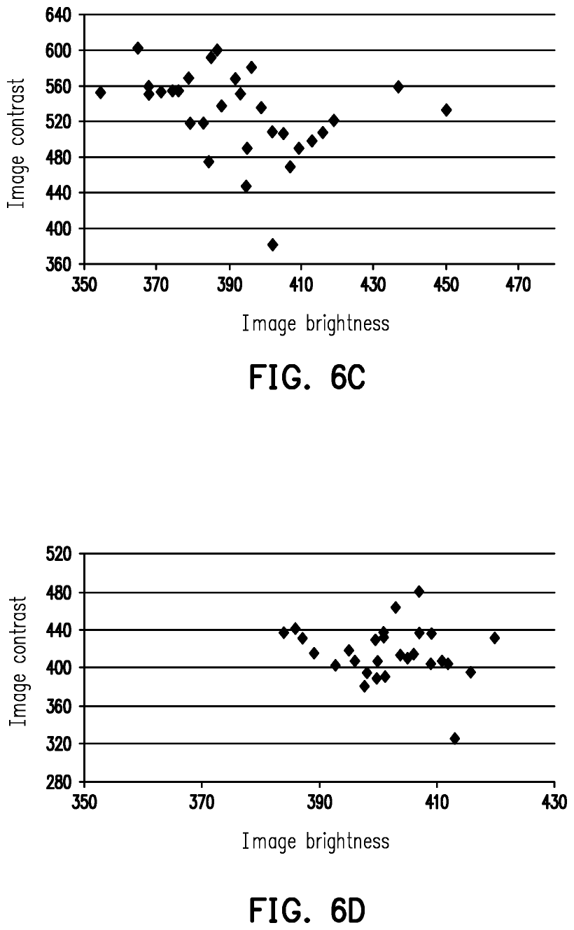

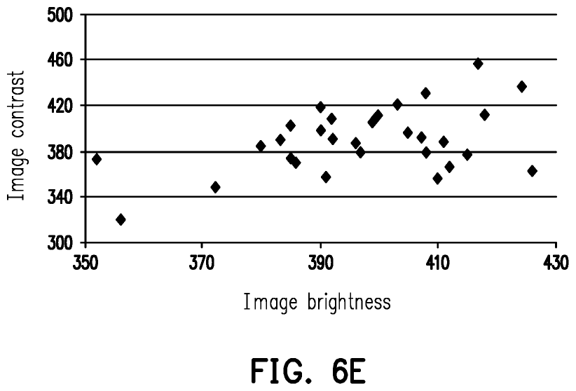

FIG. 6A is a diagram of the image contrast of the optical jig when different light valves are put therein in sequence vs. dark state brightness of the light valves. FIG. 6B is a diagram of the image contrast of the projection apparatus in FIG. 5 when different light valves having dark state brightness less than or equal to 20 lux are assembled therein with the aperture stop 300a shown in FIG. 3A in sequence vs. the serial number of measurement. FIG. 6C is a diagram of the image contrast of the projection apparatus in FIG. 5 when different light valves having dark state brightness greater than 20 and less than or equal to 22 are assembled therein with the aperture stop 300b shown in FIG. 3B in sequence vs. the image brightness of the projection apparatus. FIG. 6D is a diagram of the image contrast of the projection apparatus in FIG. 5 when different light valves having dark state brightness greater than 22 and less than or equal to 25 are assembled therein with the aperture stop 300b shown in FIG. 3B in sequence vs. the image brightness of the projection apparatus. FIG. 6E is a diagram of the image contrast of the projection apparatus in FIG. 5 when different light valves having dark state brightness greater than 25 and less than or equal to 28 are assembled therein with the aperture stop 300b shown in FIG. 3B in sequence vs. the image brightness of the projection apparatus. Referring to FIG. 6A, the square dots represents the experimental data respectively corresponding to different light valves. It can be known from FIG. 6A, the smaller the dark state brightness of the light valve 100, the higher the image contrast of the optical jig 200 when the light valve 100 is put therein. The square dots have a trend shown by the fitting line (e.g. the oblique straight line in FIG. 6A). FIG. 6B, FIG. 6C, FIG. 6D, and FIG. 6D show that the image contrast is about greater than or equal to 320 when using the manufacturing method in FIG. 1 to assemble the projection apparatus in FIG. 5, which verifies that the manufacturing method of the projection apparatus 400 in FIG. 1 can maintain high image contrast of the projection apparatus 400. The unit of the image brightness in FIG. 6C, FIG. 6C, and FIG. 6E is lumen (lm).

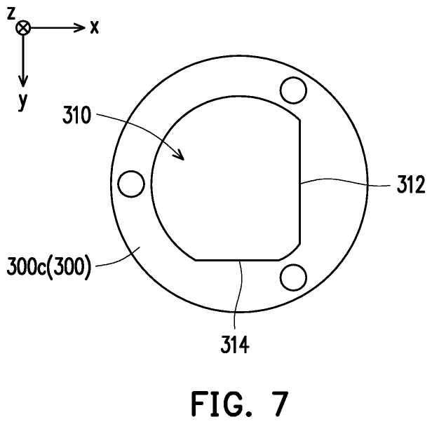

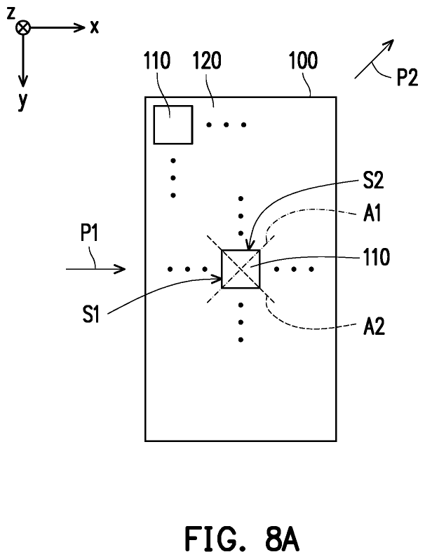

FIG. 7 shows another type of aperture stop which can be selected in a manufacturing method of the projection apparatus according to another embodiment of the invention. Referring to FIG. 3A, FIG. 3B, FIG. 5, and FIG. 7, the manufacturing method of the projection apparatus 400 in this embodiment is similar to the manufacturing method of the projection apparatus 400 in the aforementioned embodiment, and the main difference therebetween is as follows. In this embodiment, a light valve 100 is classified into three classes (i.e. three groups including the aforementioned first group, the aforementioned second group, and a third group). For example, a light valve 100 having dark state brightness less than or equal to 20 lux is classified as class 1 (the first group), a light valve 100 having dark state brightness greater than 22 lux and less than or equal to 28 lux is classified as class 2 (the second group), and a light valve 100 having dark state brightness greater than 20 lux and less than or equal to 22 lux is classified as class 3 (the third group). For the light valve 100 classified as class 1, dark state brightness is weakest, so that the aperture stop 300a (i.e. the first aperture stop) shown in FIG. 3A with a largest aperture 310 is selected. For the light valve 100 classified as class 2, dark state brightness is strongest, so that the aperture stop 300b (i.e. the second aperture stop) shown in FIG. 3B with a smallest aperture 310 is selected. For the light valve 100 classified as class 3, dark state brightness is moderate, so that the aperture stop 300c (i.e. a third aperture stop) shown in FIG. 7 with a moderate aperture 310 is selected. In other words, dark state brightness of the third group is between the dark state brightness of the first group and the dark state brightness of the second group, and a light blocking area of the third aperture stop is between the light blocking area of the first aperture stop and the light blocking area of the second aperture stop. A light valve 100 of the third group with the third aperture stop forms a Set (3). One of Set (1), Set (2), and Set (3) may be assembled into the projection apparatus 400. Adopting the aperture stop 300c may increase the image brightness when adopting the light valve 100 having dark state brightness greater than 20 lux and less than or equal to 22 lux since the aperture stop 300c has the aperture 310 with an area greater than the area of the aperture 310 of the aperture stop 300b and smaller than the area of the aperture 310 of the aperture stop 300a.

Moreover, when the aperture stops 300a, 300b, and 300c coincide, the straight side 312 of the aperture stop 300c is on the left side (−x-direction side) of the straight side 312 of the aperture stop 300a, but on the right side (+x-direction side) of the straight side 312 of the aperture stop 300b; the straight side 314 of the aperture stop 300c is on the top side (−y-direction side) of the straight side 314 of the aperture stop 300a, but on the bottom side (+y-direction side) of the straight side 314 of the aperture stop 300b.

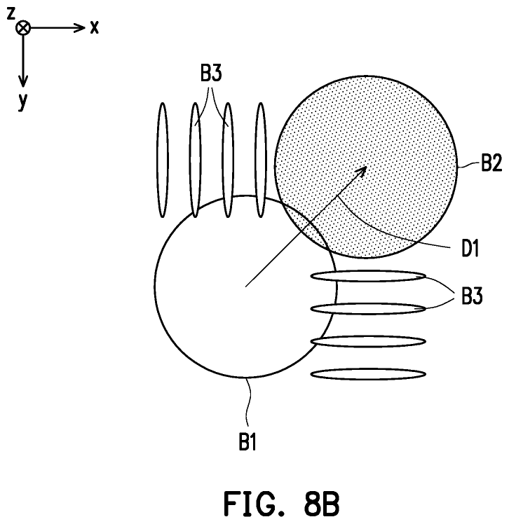

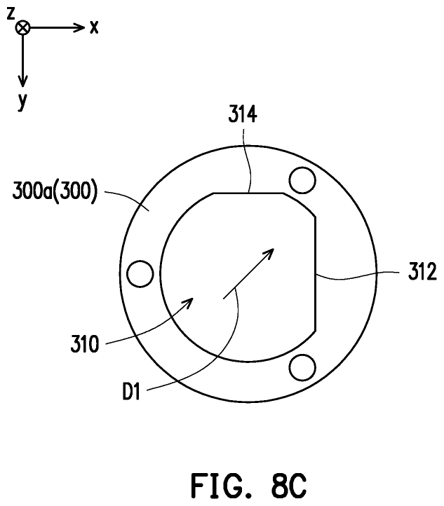

FIG. 8A shows orthogonal projections, onto a plane parallel to the light valve, of traveling directions of a light beam incident on the light valve and an off-state light beam of the light valve with respect to two tilting axes of micro-mirrors of the light valve in another embodiment of the invention. FIG. 8B shows an on-state light beam, an off-state light beam, and diffracted light of a projection apparatus according to the embodiment of FIG. 8A. FIG. 8C shows the aperture stop adopted by the embodiment of FIG. 8A. Referring to FIG. 8A, FIG. 8B, and FIG. 8C, the projection apparatus in this embodiment is similar to the projection apparatus 400 in the embodiment of FIG. 3A to FIG. 5, and the main difference therebetween is as follows. In this embodiment, the projection adopts a structure of bottom illumination; that is the orthogonal projection P1 of the light beam 422 incident on the light valve 100 is towards the long side of the light valve 100. Moreover, the orthogonal projection P2 of the off-state light beam B2 is towards the x-y direction. Besides, the rotation direction D1 of the on-state light beam B1 to an off-state light beam B2 of the light valve 100 parallel to the light valve 100 is towards the x-y direction. In addition, the side S1 is the on-state landed edge of the micro-mirror 110, and the side S2 is the off-state landed edge of the micro-mirror 110.

In the manufacturing method of the projection apparatus according to the embodiment of the invention, the light valve or DMD is first classified, so that an aperture stop matching the light valve or DMD can be then selected so as to insure a high image contrast provided by the projection apparatus.

It will be apparent to those skilled in the art that various modifications and variations can be made to the structure of the invention without departing from the scope or spirit of the invention. In view of the foregoing, it is intended that the invention covers modifications and variations of this invention provided they fall within the scope of the following claims and their equivalents.

What is claimed is:

1. A manufacturing method of a projection apparatus comprising:
classifying a plurality of digital micro-mirror devices (DMDs) into a first group and a second group according to off-state brightness of each of the DMDs, wherein each of micro-mirrors of the DMDs has two different tilting axes, the DMDs are classified by using a same optical jig comprising a lens with a constant aperture, and the optical jig projects light from each of the DMDs that passes through the constant aperture onto an image plane; and
assembling one of following sets into the projection apparatus: Set (1): a DMD of the first group with a first aperture stop; Set (2): a DMD of the second group with a second aperture stop, wherein off-state brightness of the first group is less than off-state brightness of the second group, and a light blocking area of the first aperture stop is less than a light blocking area of the second aperture stop.

2. The manufacturing method of the projection apparatus according to claim 1, wherein the DMDs are classified into the first group, the second group, and a third group according to the off-state brightness of each of the DMDs, and said following sets further comprises Set (3): a DMD of the third group with a third aperture stop, and wherein off-state brightness of the third group is between the off-state brightness of the first group and the off-state brightness of the second group, and a light blocking area of the third aperture stop is between the light blocking area of the first aperture stop and the light blocking area of the second aperture stop.

3. The manufacturing method of the projection apparatus according to claim 1, wherein the optical jig further comprises an optical meter configured to measure the off-state brightness of the DMD on the image plane.

4. The manufacturing method of the projection apparatus according to claim 3, wherein the optical meter is configured to measure illuminance at a center of the light from each of the DMDs on the image plane.

5. The manufacturing method of the projection apparatus according to claim 1, wherein the aperture stop has an aperture having two straight sides, a rotation direction of an on-state light beam to an off-state light beam of the DMD parallel to the DMD and an extension direction of each of the two straight sides make an included angle, and the included angle is substantially 45 degrees.

6. The manufacturing method of the projection apparatus according to claim 1 further comprising:
after classifying the DMD into the first group and the second group, respectively assigning a first part number and a second part number to the first group and the second group; and
putting the first group with the first part number and the second group with the second part number into storage.

7. A manufacturing method of a projection apparatus comprising:
classifying a plurality of digital micro-mirror devices (DMDs) into a first group and a second group according to off-state brightness of each of the DMDs, wherein a diffracted light of an off-state of each of the DMDs overlaps a path of an on-state light beam of the DMD, the DMDs are classified by using a same optical jig comprising a lens with a constant aperture, and the optical jig projects light from each of the DMDs that passes through the constant aperture onto an image plane; and
assembling one of following sets into the projection apparatus: Set (1): a DMD of the first group with a first aperture stop; Set (2): a DMD of the second group with a second aperture stop, wherein off-state brightness of the first group is less than off-state brightness of the second group, and a light blocking area of the first aperture stop is less than a light blocking area of the second aperture stop.

8. The manufacturing method of the projection apparatus according to claim 7, wherein the DMDs are classified into the first group, the second group, and a third group according to the off-state brightness of each of the DMDs, and said following sets further comprises Set (3): a DMD of the third group with a third aperture stop, and wherein off-state brightness of the third group is between the off-state brightness of the first group and the off-state brightness of the second group, and a light blocking area of the third aperture stop is between the light blocking area of the first aperture stop and the light blocking area of the second aperture stop.

9. The manufacturing method of the projection apparatus according to claim 7, wherein the optical jig further comprises an optical meter configured to measure the off-state brightness of the DMD on the image plane.

10. The manufacturing method of the projection apparatus according to claim 9, wherein the optical meter is configured to measure illuminance at a center of the light from each of the DMDs on the image plane.

11. The manufacturing method of the projection apparatus according to claim 7, wherein the aperture stop has an aperture having two straight sides, a rotation direction of an on-state light beam to an off-state light beam of the DMD parallel to the DMD and an extension direction of each of the two straight sides make an included angle, and the included angle is substantially 45 degrees.

12. The manufacturing method of the projection apparatus according to claim 7 further comprising:
after classifying the DMD into the first group and the second group, respectively assigning a first part number and a second part number to the first group and the second group; and
putting the first group with the first part number and the second group with the second part number into storage.

13. A manufacturing method of a projection apparatus comprising:
putting a light valve on an optical jig;
providing a light beam to the light valve, wherein the light valve converts the light beam into an image beam, the optical jig comprises a lens with a constant aperture, and the optical jig projects the image beam that passes through the constant aperture onto an image plane;
measuring brightness on the image plane when the light valve in the off-state;
classifying the light valve according to the brightness on the image plane;
selecting an aperture stop with a size corresponding to classification of the light valve; and
assembling the light valve and the aperture stop to form the projection apparatus.

14. The manufacturing method of the projection apparatus according to claim 13, wherein the optical jig further comprises an optical meter is configured to measure the brightness on the image plane.

15. The manufacturing method of the projection apparatus according to claim 13, wherein each class of the light valve corresponds to a different brightness range, and a class of the light valve corresponding to a brightness range having greater brightness corresponds to an aperture stop having a smaller aperture.

16. The manufacturing method of the projection apparatus according to claim 13, wherein the light valve is a digital micro-mirror device.

17. The manufacturing method of the projection apparatus according to claim 16, wherein the aperture stop has an aperture having two straight sides, a rotation direction of an on-state light beam to an off-state light beam of the light valve parallel to the light valve and an extension direction of each of the two straight sides make an included angle, and the included angle is substantially 45 degrees.

18. The manufacturing method of the projection apparatus according to claim 13 further comprising:
after classifying the light valve, assigning a part number to the light valve, wherein the part number corresponds to the classification of the light valve; and
putting the light valve with the part number into storage, wherein selecting the aperture stop with the size corresponding to the classification of the light valve is selecting the aperture stop with the size corresponding to the part number.
